(19) United States
(12) Patent Application Publication
(10) Pub. No.: US 2024/0169090 A1
(43) Pub. Date: May 23, 2024

(54) PERSONA PROFILE AND PROBE REFINER WITH DISTRIBUTED HYBRID MULTI-CLOUD OBSERVABILITY ASSURANCE

(71) Applicant: INTERNATIONAL BUSINESS MACHINES CORPORATION, Armonk, NY (US)

(72) Inventors: Shweta VOHRA, Bangalore (IN); Narayana Aditya MADINENI, Ferny Hills (AU); Sreekanth Ramakrishna IYER, Bangalore (IN)

(21) Appl. No.: 18/056,881

(22) Filed: Nov. 18, 2022

(51) Int. Cl. G06F 21/62

(52) U.S. Cl. CPC G06F 21/6245

(57) ABSTRACT

Provided are techniques for a persona profile and a probe refiner with distributed hybrid multi-cloud observability assurance. A persona profile is created, where the persona profile is associated with a persona and comprises a configuration that identifies data to be retrieved for the persona. A probe is identified for the persona profile. The persona profile and the probe are deployed to one or more cloud environments of a hybrid multi-cloud environment to generate probe data. The probe data is verified to determine whether the data to be retrieved for the persona has been retrieved and to generate verification data. The verification data is analyzed to generate one or more recommendations to refine at least one of the persona profile and the probe. At least one of the persona profile and the probe are refined based on the one or more recommendations.

### BACKGROUND

Embodiments of the invention relate to a persona profile and a probe refiner. In addition, embodiments of the invention relate to a persona profile and a probe refiner with distributed hybrid multi-cloud observability assurance.

Currently, enterprises are moving towards a hybrid multi-cloud environment in which different components of an industry use-case solution span across multiple cloud infrastructures (e.g., private cloud and/or public cloud) and on-premises (“on-prem”) infrastructures.

In this environment, transactions are logged, and the existing logging approaches take a system or application centric approach to logging. There may be a large quantum of logs.

In addition, conventional implementations and solutions are specific to a target cloud, which makes it difficult to validate or enforce: a policy across multiple cloud environments, application features across the multiple cloud environments or scenarios across the multiple cloud environments.

### SUMMARY

In accordance with certain embodiments, a computer-implemented method comprising operations is provided for a persona profile and a probe refiner. In such embodiments, a persona profile is created, where the persona profile is associated with a persona and comprises a configuration that identifies data to be retrieved for the persona. A probe is identified for the persona profile. The persona profile and the probe are deployed to one or more cloud environments of a hybrid multi-cloud environment to generate probe data. The probe data is verified to determine whether the data to be retrieved for the persona has been retrieved and to generate verification data. The verification data is analyzed to generate one or more recommendations to refine at least one of the persona profile and the probe. At least one of the persona profile and the probe are refined based on the one or more recommendations.

In accordance with other embodiments, a computer program product is provided for a persona profile and a probe refiner. The computer program product comprises a computer readable storage medium having program code embodied therewith, the program code executable by at least one processor to perform operations. In such embodiments, a persona profile is created, where the persona profile is associated with a persona and comprises a configuration that identifies data to be retrieved for the persona. A probe is identified for the persona profile. The persona profile and the probe are deployed to one or more cloud environments of a hybrid multi-cloud environment to generate probe data. The probe data is verified to determine whether the data to be retrieved for the persona has been retrieved and to generate verification data. The verification data is analyzed to generate one or more recommendations to refine at least one of the persona profile and the probe. At least one of the persona profile and the probe are refined based on the one or more recommendations.

In accordance with yet other embodiments, a computer system is provided for a persona profile and a probe refiner. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations. In such embodiments, a persona profile is created, where the persona profile is associated with a persona and comprises a configuration that identifies data to be retrieved for the persona. A probe is identified for the persona profile. The persona profile and the probe are deployed to one or more cloud environments of a hybrid multi-cloud environment to generate probe data. The probe data is verified to determine whether the data to be retrieved for the persona has been retrieved and to generate verification data. The verification data is analyzed to generate one or more recommendations to refine at least one of the persona profile and the probe. At least one of the persona profile and the probe are refined based on the one or more recommendations.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates components of FIG. 1 and data flow in accordance with certain embodiments.

FIGS. 3A and 3B illustrate, in a flowchart, operations for distributed hybrid multi-cloud observability assurance in accordance with certain embodiments.

FIG. 4 illustrates, in a flowchart, operations performed by the refiner system in accordance with certain embodiments.

FIG. 5 illustrates, in a block diagram, details of a machine learning model in accordance with certain embodiments.

FIG. 6 illustrates a computing environment in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

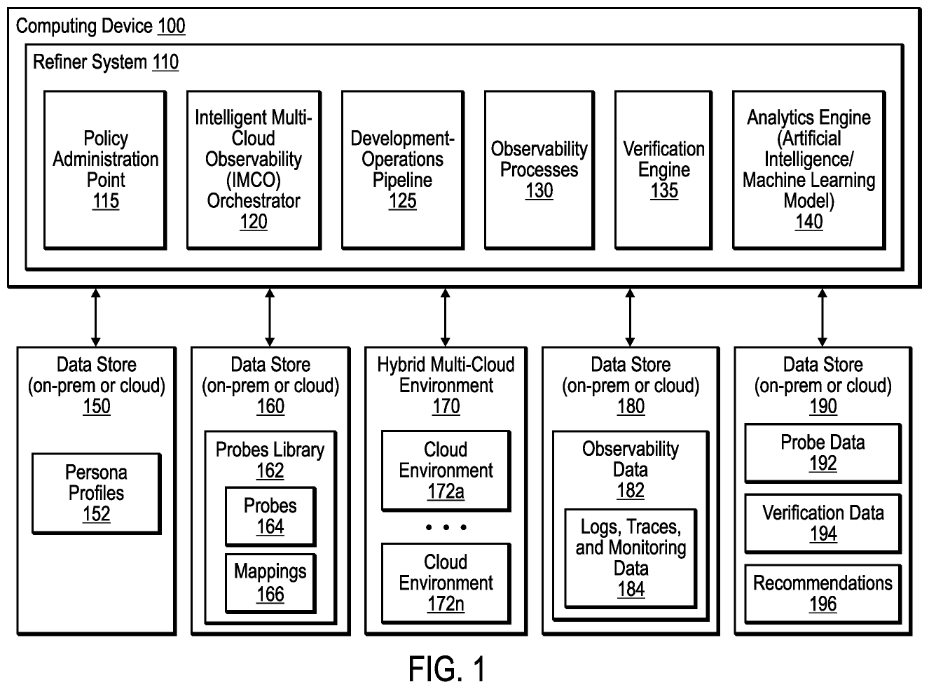

FIG. 1 illustrates, in a block diagram, a computing environment in accordance with certain embodiments. In FIG. 1, a computing device 100 includes a refiner system 110. The refiner system 110 includes a policy administration point 115, an Intelligent Multi-Cloud Observability (IMCO) orchestrator 120, a development-operations pipeline 125, observability processes 130, a verification engine 135, and an analytics engine (Artificial Intelligence (AI) or machine learning model) 140. In certain embodiments, the components 115, 120, 125, 130, 135, and 140 of the refiner system 110 may execute on different computing devices and communicate with each other.

The computing device 100 is connected to a data store 150 that stores persona profiles 152 (also referred to as “profiles”). Also, the computing device 100 is connected to a data store 160 that stores a probes library 162 containing probes 164 (also referred to as “persona profile probes” or “observability probes”) and mappings 166 (which are persona profile to probe mappings). In addition, the computing device 100 is connected to a hybrid multi-cloud environment 170 that includes cloud environments 172a . . . 172n (also referred to as “hybrid cloud environments”). Moreover, the computing device 100 is connected to data store 180 that stores observability data 182 (generated by the observability processes 130). The observability data 182 includes logs, traces, and monitoring data 184. Furthermore, the computing device 100 is connected to a data store 190 that stores probe data 192, verification data 194 (generated by the verification engine 135) and recommendations 196 (generated by the analytics engine 140). In other embodiments, the probe data 192, the verification data, and the recommendations 196 may be stored in different data stores.

The probes 164 may be described as obtaining probe data 192 by connecting to a source (the observability data 182), detecting and acquiring the data in accordance with the profile 152 (and this data may be referred to as probe data 192), and forwarding or storing the probe data 192. That is, the probe164 uses the rules specified in the configuration of the persona profile 152 to obtain specific data, referred to as the probe data 192. The rules of the configuration in the persona profile 152 may be said to define what data is to be collected for a particular persona for the persona profile 152. A probe 164 may acquire data from any data source, such as the logs, traces, and monitoring data 184. In certain embodiments, the probe data 192 includes data that the probe 164 collected from the logs, traces, and monitoring data 184 for a particular cloud environment. Using this probe data 192, the probe 164 and/or the persona profile 152 are refined (e.g., updated, aligned or enriched) per persona-specific priorities that are defined in the persona profile 152.

The IMCO orchestrator 120 allows for creating, refining (e.g., updating, aligning or enriching), and deleting the persona profiles 152. In certain embodiments, the IMCO orchestrator 120 identifies one or more probes 164 for a persona profile 152 and initiates deployment of the one or more probes 164 via the development-operations pipeline 125.

The development-operations pipeline 125 deploys the one or more probes 164 to the hybrid multi-cloud environment 170. The verification engine 135 performs a probes 164 versus enforcement analysis and outputs verification data 194 to the analytics engine 140. The analytics engine 140 analyzes the verification data 194 from the verification engine 135 and identifies recommendations 196 to refine (e.g., update, align or enrich) the probes 164 and/or to refine (e.g., update, align or enrich) the persona profiles 152.

To meet objectives for transactions, the usefulness of logs, traces, and monitoring data 184 (which include telemetry (measurements)) depends on the persona-type reviewing the logs, traces, and monitoring data 184 and on the data quality. The persona profile 152 for a persona may be role based, with areas of interest and concerns varying across roles. Examples of roles include developers, security administrators, auditors, third party component owners, partners, end users (for any cloud service or resource), cloud administrators, testers, business owners, etc.

In addition, the persona profile 152 for a persona may be operations based. For example, operations based personas may be AI operations (AI-ops), developer operations (dev-ops), git operations (git-ops), developer security operations (dev-sec-ops), data operations (data-ops), financial operations (fin-ops), etc.

Moreover, the persona profile 152 for a persona may be custom-based. The custom-based persona profile 152 may specify a resource type to meet regulatory or compliance requirements. Such custom-based persona profile 152 may specify monitoring of applications/business data objects and sales plan, price or quantity change, etc. Such custom-based persona profile 152 may specify cloud resources and services (e.g., storage, certificates, keys, databases, etc.). Such custom-based persona profile 152 may specify tracing/data lineage for Personally Identifiable Information (PII) or sensitive information (e.g., credit card data, social security numbers, etc.).

Different user personas leverage different logs for different objectives, such as operational effectiveness, trouble shooting, security, business monitoring, financial analysis, etc. For example, a developer may want to troubleshoot applications repeatedly, while a security administrator may want to ensure compliance frequently. With embodiments, the refiner system 110 enables learning and periodically refining the persona profiles 152 and the probes 164 based on analytics and utilization metrics. This allows for a persona profile-based approach to observability and assurance for logs, traces, and monitoring data 184 across the distributed hybrid multi-cloud environment 170.

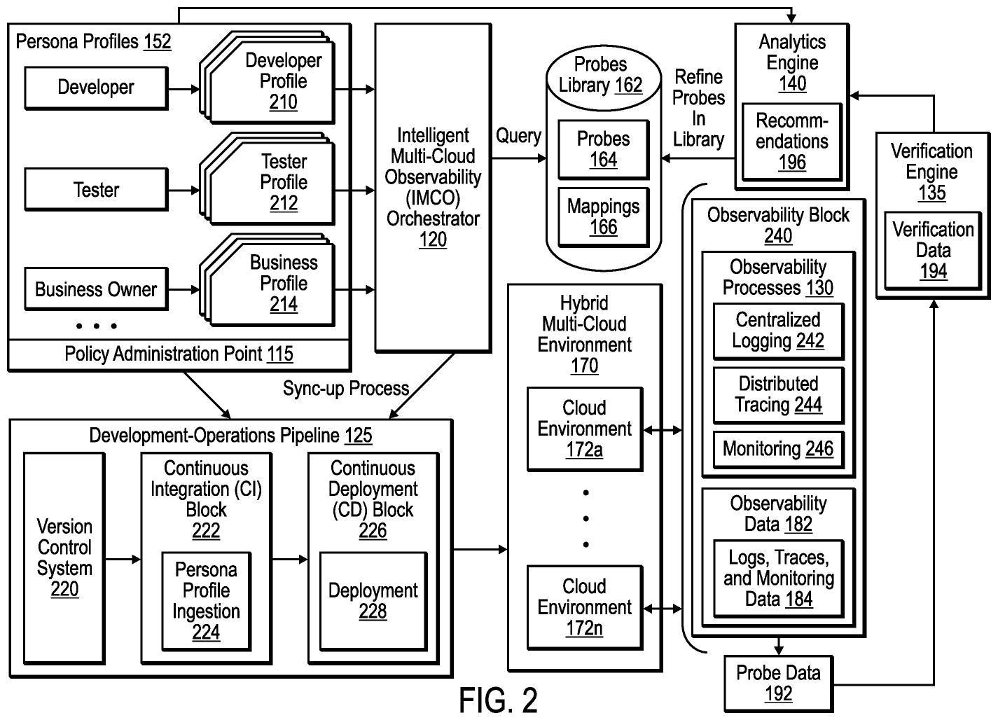

FIG. 2 illustrates components of FIG. 1 and data flow in accordance with certain embodiments. In FIG. 2, the persona profiles 152 include one or more developer profiles 210 for a developer (or a group of developers), one or more tester profiles 212 for a tester (or a group of testers), one or more business profiles 214 for a business owner (or a group of business owners).

In certain embodiments, the IMCO orchestrator 120 enables creation of the persona profiles 152. In certain embodiments, the version control system 220 enables creation of the persona profiles 152 and stores the persona profiles 152. In certain embodiments, the persona profiles 152 may be created with another tool and fed into the IMCO orchestrator 120 and the development-operations pipeline 125. The policy administration point 115 continuously ingests persona profiles 152 and sends the persona profiles 152 to the development-operations pipeline 125 for storage in the version control system 220 (e.g., a git system).

In certain embodiments, the IMCO orchestrator 120 queries the probes library 162 for one or more probes 164 based on a particular persona profile 152 and sends the one or more probes 164 and the particular persona profile 152, to the development-operations pipeline 125 for deployment by the Continuous Deployment (CD) block 226 (also referred to as a “CD pipeline”). Then, the CD block deploys the one or more probes 164 and the particular persona profile 152 to the different cloud environments 172a.. . 172n.

Within the development-operations pipeline 125, the version control system 220 stores versions of the persona profiles 152 and sends the persona profiles 152 (without additional processing) to the Continuous Integration (CI) block 222 (also referred to as a “CI pipeline”). The persona profiles 152 may be continuously refined (updated) by the different personas (e.g., developer). The CI block 222 includes persona profile ingestion 224. The CI block 222 performs build and conversion tasks. For example, the CI block 222 may convert the persona profiles 152 per different cloud environment provider policies (e.g., requirements) and bundles these converted persona profiles 152 along with other artifacts, which are then routed to the CD block 226. In certain embodiments, artifacts include build files, such as executables, configurations, Infra-as-code specific configurations, etc. In certain embodiments, the CD block 226 includes deployment 228 and deploys the converted persona profiles 152 and probes 164 to the different cloud environments 172a . . . 172n.

With embodiments, different tools may be used for deployment 228, and, depending on the tools used, particular probes 164 in particular formats are deployed to specific cloud environments 172a . . . 172n. For example, probe A in format 123 may be deployed to cloud environment xyz. The probes 164 execute to obtain the probe data 192 based on associated persona profiles 152. In certain embodiments, multiple probes 164 may be deployed on multiple cloud environments 172a . . . 172n based on the processing performed by the CI block 222 and the CD block 226 for bundling and deployment on respective hybrid multi-cloud environments 172a . . . 172n. The probe data 192 includes data that the persona profile 152 identified for the probe 164 to obtain.

The hybrid multi-cloud environment 170 includes cloud environments 172a . . . 172n. The cloud environments 172a . . . 172n may be from different providers and may store data in different formats. In certain embodiments, each cloud environment 172a . . . 172n, may be a hyperscaler cloud environment. With embodiments, each cloud environment 172a . . . 172n may include the observability block 240. With embodiments, each probe 164 generates its own set of probe data 192.

The observability block 240 includes the observability processes 130 and the observability data 182. The observability processes 130 include centralized logging 242 for generating logs, distributed tracing 244 for generating traces, and monitoring 246 for generating monitoring data 184. The observability data 182 includes the logs, the traces, and the monitoring data 184.

A probe 164, which is associated with a persona profile 152, is deployed to one or more of the cloud environments 172a . . . 172n, and the probe 164 obtains data from the observability data 182 for each cloud environment 172a . . . 172n. The probe 164 stores this data as probe data 192. The obtained data represents the data that the configuration of the persona profile 152 requested.

The verification engine 135 performs a probes versus enforcement analysis. With embodiments, the verification engine 135 analyzes the persona profiles 152 associated with the probes 164 with reference to the probe data 192 to validate the persona profiles 152 and the probes 164 and to determine whether the persona profiles 152 and/or the probes 164 are to be refined. In certain embodiments, the verification engine 135 performs enforcement analysis, which includes filtering and grouping of the probe data 192 with respect to the persona profile requirements defined in the persona profile 152 and logical collection of observability data as per cloud environment provider (i.e., vendor) policies. This filtered and grouped data is sent from the verification engine 135 to the analytics engine 140, along with persona profiles 152, and the analytics engine runs intelligence on top of the verification data 194 and the persona profiles 152 to convert the filtered and grouped data into recommendations for refining the persona profile 152 and/or the probe 164.

For the example of FIG. 2, the personas associated with the use case include developer, tester, and business owner. Also, users may create persona profiles 152 based on persona-specific requirements. For example, a developer profile may include a configuration of logs to troubleshoot an application. In addition, a cloud administrator profile may include a configuration to collect the details of the cloud resource consumption. Also, a business owner profile may include a configuration to collect insights on features, plans, and quota usage. Moreover, a security administrator profile may include a configuration to collect audit and compliance events. Furthermore, a tester profile includes a configuration to collect performance metrics and error/exception occurrences.

With embodiments, the created persona profiles 152 may be created and stored by the version control system 220 and/or created by the IMCO orchestrator 120 and fed into the development-operations pipeline 125.

With embodiments, the IMCO orchestrator 120 receives the persona profiles 152 as input. Each persona profile 152 specifies one or more target cloud environments 172a . . . 172n. For each persona profile 152, the IMCO orchestrator 120 queries the probes library 162 to retrieve the latest refined probes 164 mapping to a specific target cloud environment 172a . . . 172n (specified in the persona profile 152).

In certain embodiments, the IMCO orchestrator 120 processes the persona profiles 152 and probes 164 for a common set of hybrid multi-cloud environments 172a . . . 172n. That is, the same persona profile 152 and associated probe 164 may be deployed on multiple cloud environments 172a . . . 172n. The IMCO orchestrator 120 sends the probes 164 to the CI block 222 of the development-operations pipeline 125. In this manner, the IMCO orchestrator 120 obtains the latest, refined probes 164 and gets them to the CD block 226 for deployment.

Thus, there are two possible routes to deploying the probes 164. In certain embodiments, the IMCO orchestrator 120 identifies the probes 164 and associated persona profiles 152 sends these to the CD block 226 for deployment. In other embodiments, each persona profile 152 is sent to the CI block 222, which identifies the probes 164 (e.g., in accordance with policies) that the CD block 226 is to deploy.

In certain embodiments, the IMCO orchestrator 120 continuously sends refined probes 164 through the CD block 226 using agent-less configurations found in the persona profiles 152. The IMCO orchestrator 120 ensures that refined probes 164 in the probes library 162, which were created by the analytics engine 140, are continuously refined through the deployment, verification (performed by the verification engine 135), and analytics (performed by the analytics engine 140).

With embodiments, the probes 164 may be said to be “enforced”, and this refers to continuous learning and refinement from observability through the IMCO orchestrator 120, which continuously triggers the intelligence on the persona profiles 152 and probes 164 through the CD block 226.

The policy administration point 115 continuously sends the persona profiles 152 to the development-operations pipeline 125 (either to block 220 or 222, depending on the embodiment). With embodiments, the policy administration point 115 continuously ingests the persona profiles 152 by processing the persona profiles 152 in accordance with new/edited polices to adapt to different or changing CI block 222 and/or CD block 226. Then, the CD block 226 may identify probes 164 for deployment based on policies (which may be the same policies used by the policy administration point 115 or different policies). In addition, users associated with personas (who may be humans or software applications) may continuously refine persona profiles 152, either through the IMCO orchestrator 120 or through the version control system 220.

The IMCO orchestrator sends the refined persona profiles 152 to the development-operations pipeline 126. With embodiments, the refined persona profiles 152 are synced up for continuous learning and are immediately fed into the development-operations pipeline 125 for integration. With embodiments, users associated with personas have the option to change and reflect their continuous observability preferences by updating the persona profiles 152, and that is continuously provided/integrated or synced up with the development-operations pipeline 125.

This ingestion process may be induced at any suitable build and integration stage of the development-operations pipeline 125. Also, the CI block 222 acts as a continuous policy administration point for persona profile ingestion (e.g., by convert the persona profiles 152 per different cloud environment provider policies).

With embodiments, a persona profile 152 may be described as a persona-based observability configuration in a user defined format. The configuration may be described as a set of rules and priorities associated with those rules. With embodiments, the priorities may be associated with log items, trace items, and monitoring data items. A probe 164 may be described as specific to a particular cloud environment 172a . . . 172n and may vary based on provider and type of deployment (e.g., edge computing, on-prem, private, public, hybrid, etc.).

The probes library 162 stores mappings 166 between persona profiles 152 and probes 164 specific to target cloud environments 172a . . . 172n. The IMCO orchestrator 120 queries the mappings 166 using the persona profiles 152 and identifies the probes 164. The analytics engine 140 refines the probes 164 in the probes library 162 to mitigate found enforcement misconfigurations or missing configurations. The probes library 162 has the latest refined probes 164, which are in-turn continuously deployed by the IMCO orchestrator 120 into the CD block 226.

The deployment 228 ensures that the latest, refined probes 164 are deployed on the cloud environments 172a . . . 172n. The IMCO orchestrator 120 ingests the latest, refined probes 164 to the CD block 226. These latest, refined probes 164 are applied for the target cloud environments 172a . . . 172n to generate observability data 182 by utilizing independent environment specific resources. For example, on a web services cloud environment, the probes 164 may be ingested in the form of various filters. In other cloud environments, the probes 164 may be cloud provider specific observability filters. With embodiments, the probes 164 may utilize existing observability processes 130 for probing persona specific logs, traces, and monitoring data 184 based on the persona profiles 152.

Embodiments ensure that the probes 164 reach respective cloud environments 172a . . . 172n in desired formats. That is, tools and cloud environment providers may vary, and so the information may be required in different formats. For example, one cloud environment provider may expect data to be given in some storage location such as S3 buckets as object on a cloud environment, whereas some other tools may expect information in key/value pairs. Embodiments ensure that, while processing various types of observability data 182 (i.e., logs, traces, and monitoring data 184), the persona probes 164 are considered and results are returned by the probes 164 in the desired formats.

With embodiments, the verification engine 135 performs validation of expected probe results against actual enforcement results based on the probe data 192 to generate verification data 194. With embodiments, some samplers of the data is taken at different intervals and shared with the analytics engine 140. With embodiments, the persona profiles 152 and probes 164 are verified as enabled for the specific cloud environment 172a . . . 172n. This verification is performed across the centralized logging 242, the distributed tracing 246, and the monitoring 248 provided natively by the target cloud environment 172a . . . 172n or supported by third party tools. With embodiments, the properties and similarities of data across different cloud observabilities are analyzed. The capability of the target cloud environment 172a . . . 172n to provide the right level of enforcement in accordance with the policy is analyzed. The output of this processing provides formatted input for the analytics engine 140.

The analytics engine 140 leverages environment specific services to perform analytics and determine refinements to the probes 164. The analytics engine 140 may also automatically refine the probes 164 based on the determined refinements. The analytics engine 140 receives verification data 194 as input from the verification engine 135, which validates whether the enforcement results reflect the results requested in the persona profile 152. The analytics engine 140 applies artificial intelligence and improves the persona observability over time. In this manner, the same persona probes 164 are percolated across different cloud environments 172a . . . 172n and are continuously enriched/refined with meaningful observability data 182. The refined probes 164 reflect the latest state of the persona probes 164.

The analytics engine 140 performs analytics to determine observability assurance and generates recommendations 196 for probe refinements and persona profile refinements. The analytics engine 140 receives input of verification data 194 from the verification engine 135. For the observability enforcement quality metrics analysis, examples of measured metrics are:
Observability Data Occurrence Fairness Point—this is the number of times similar logs are observed across different cloud environments.
Utilization Metrics—based on user defining certain logs to be collected, while the observability data 182 indicates that these logs were never used. These metrics indicate certain configurations may be removed from the persona profile152.
Misconfiguration Metrics—the user specified one or more filters, while the probe data 192 indicates that the one or more filters did not get desired results. These metrics indicate missing persona profile configurations that are to be added to the persona profiles 152.
Persona Profile Configuration vs Consumption Differences of Observability Data—the user consumption patterns are different on different cloud environments 172a . . . 172n. These metrics indicate that the probes 164 are to be refined for specific target cloud environments 172a . . . 172n.
Severity and Impact Analysis of Logs—for example, lambda throughput exceptions are causing system failure for a certain number of times. These metrics may be of interest to developer persona and indicate refinement of the developer persona.

The analytics engine 140 provides recommendations 196 for refinements of the probes for observability assurance based on the metrics. For example, the refinements may indicate classifying probes that are high priority and critical impact, low priority, and low to no occurrence.

With embodiments, the outputs from the analytics engine 140 are refined probes 164 and information such as: probes 164 that are prioritized (i.e., persona specific prioritized observability probes), the fairness point of each probe 164, and probes 164 that may be dropped (due to continuous non-occurrence).

With embodiments, a persona based observability persona profile 152 is defined to capture logging, tracing, and monitoring requirements across hybrid multi-cloud environments 172a . . . 172n.

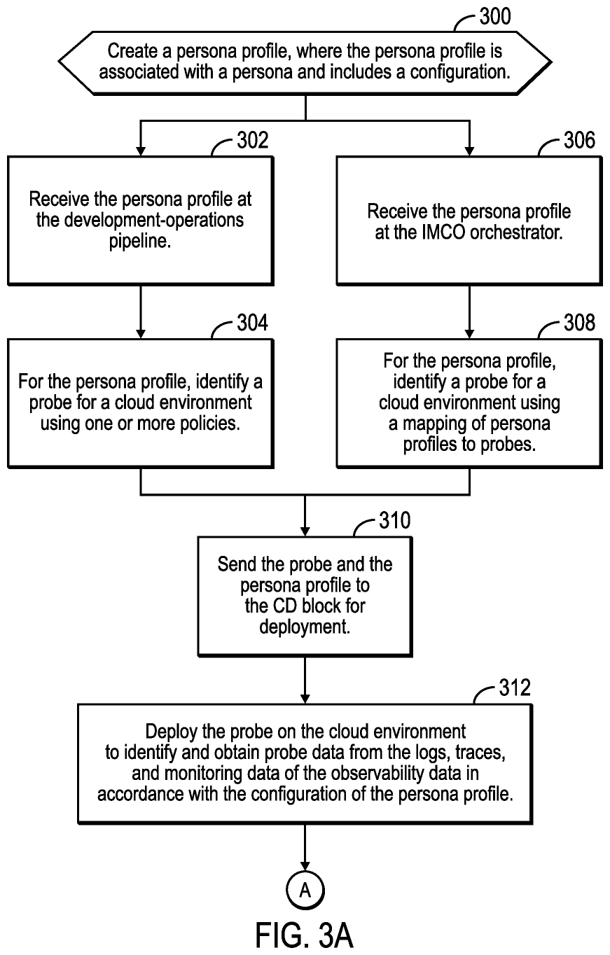

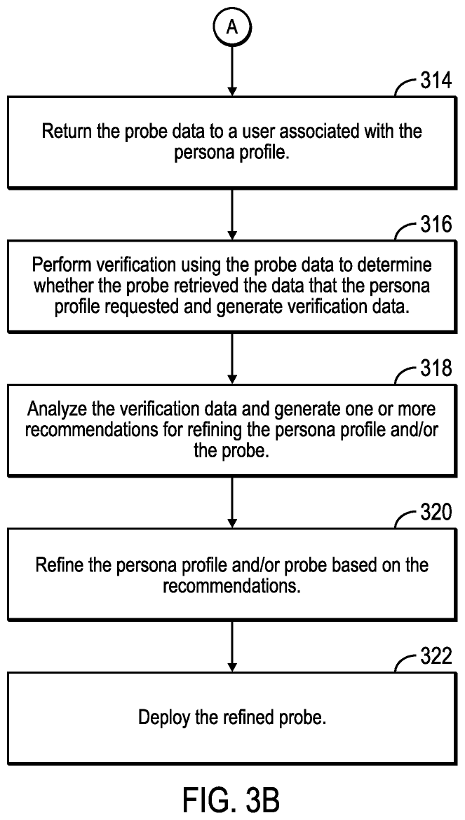

FIGS. 3A and 3B illustrate, in a flowchart, operations for distributed hybrid multi-cloud observability assurance in accordance with certain embodiments. Control begins at block 300 with the IMCO orchestrator 120, the version control system 220 or another tool creating a persona profile (in response to user input), where the persona profile is associated with a persona and includes a configuration. The configuration is used by a probe 164 to obtain specific data for that persona from the logs, traces, and monitoring data 184 based on the configuration. From block 300, processing may go from block 302 and/or to block 306.

In block 302, the persona profile 152 is received at the development-operations pipeline. With embodiments, the version control system 220 “receives” the persona profile 152 by enabling creation of the persona profile 152. With other embodiments, the version control system 220 or the DI block receive the persona profile 152 from the policy administration point 115 (e.g., because another tool was used to create the persona profile 152). In block 304, for the persona profile 152, the CI block 222 identifies a probe for a cloud environment 172a . . . 172n using one or more policies.

In block 306, the persona profile 152 is received at the IMCO orchestrator 120. With embodiments, the IMCO orchestrator 120 “receives” the persona profile 152 by enabling creation of the persona profile 152. With other embodiments, the IMCO orchestrator 120 receives the persona profile 152 from the policy administration point 115 (e.g., because another tool was used to create the persona profile 152). In block 308, for the persona profile, the IMCO orchestrator 120 identifies a probe for a cloud environment 172a . . . 172n using the mappings 166 of persona profiles 152 to probes 164.

In certain embodiments, if the IMCO orchestrator 120 creates the persona profiles 152, the IMCO orchestrator 120 has access to the persona profiles 152, and, if the version control system 220 creates the persona profiles 152, the IMCO orchestrator 120 retrieves the persona profiles 152 from the version control system 220. In certain embodiments, the policy administration point 115 sends the persona profiles 152 to the development-operations pipeline 125, where the version control system 220 stores the persona profiles 152, and the CI block 222 to ingests the persona profiles 152 (by the CI block 222).

In block 310, the probe 164 and the persona profile 152 are sent to the CD block 226 for deployment. When processing moves from block 306 to block 310, the CI block 222 sends the probe 164 and the profile 152 to the CD block 226. When processing moves from block 308 to block 310, the IMCO orchestrator 120 sends the probe 164 and the profile 152 to the CD block 226.

In block 312, the CD block 226 deploys the probe 164 on the cloud environment 172a . . . 172n to identify and obtain probe data 192 from the logs, traces, and monitoring data 184 in accordance with the configuration of the persona profile 152 and to generate probe data 192. That is, the configuration of the persona profile 152 indicates what data is relevant to the persona for that persona profile 152 so that the probe 164 knows which data to look for. The persona profile 152 may be sent to one or more cloud environments 172a . . . 172n, along with the probe 164. Each cloud environment 172a . . . 172n has an observability block 240 with the observability processes 130 generating observability data 182 for that cloud environment 172a . . . 172n. Thus, the probe 164 identifies data from the logs, traces, and monitoring data 184 in accordance with rules of the configuration in the persona profile 152 to obtain persona specific data.

From block 312 (FIG. 3A), processing continues to block 314 (FIG. 3B). In block 314, the probe 164 returns the probe data 192 to a user associated with the persona profile 152. An example probe 164 may be in the form: <LOG_2365; Occurrence:50; Relevancy:DeveloperProfile; Priority:High>. This example probe 164 obtains data from LOG_2365, is relevant to a developer profile, and has a high priority. In addition, “Occurrence” indicates that this log was reported 50 times by the observability processes 130.

In block 316, the verification engine 135 performs verification using the probe data 192 to determine whether the probe 164 retrieved the data that the persona profile 152 requested and generates verification data 194.

In block 318, the analytics engine 140 analyzes the verification data 194 and generates one or more recommendations 196 for refining the persona profile 152 and/or the probe 164.

In block 320, the analytics engine 140 refines the persona profile 152 and/or probe 164 based on the recommendations. With embodiments, the refines persona profile 152 may be stored as another version of the persona profile 152 in the version control system 220. In certain embodiments, the persona profile 152 is refined by removing a configuration (so that the probe 164 does not look for information defined by that configuration (e.g., because that data is no longer being generated). In certain embodiments, the persona profile 152 is refined by adding a configuration (so that the probe 164 looks for information defined by that configuration). In certain embodiments, the probe 164 is refined based on the policies of a cloud environment 172a . . . 172n.

In block 322, the IMCO orchestrator 120 deploys the refined persona profile and/or probe 164. This allows for a another cycle of generating probe data 192 and determining additional refinements to the persona profile 152 and/or the probe 164. In certain embodiments, the deployment of the refined probe 164 is performed based on a trigger (e.g., an update to the profile 152 by a user, a period of time, etc.).

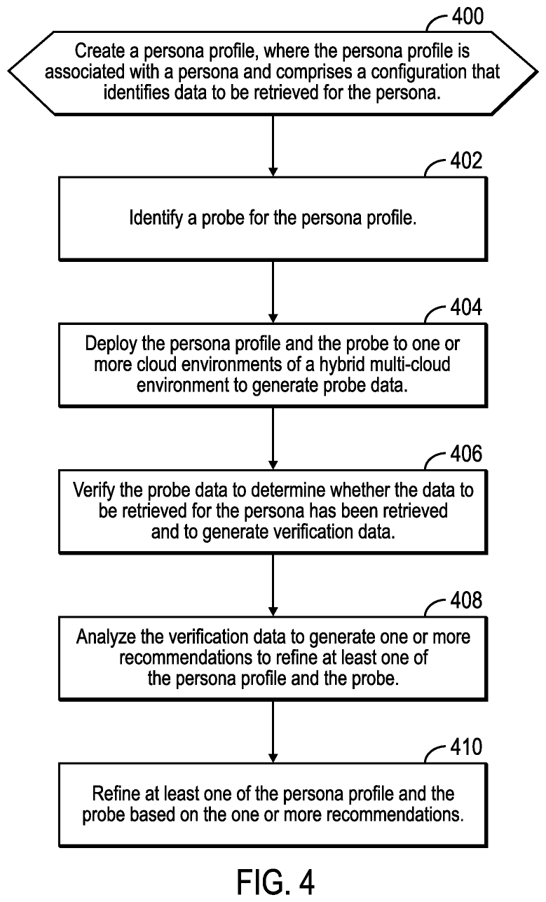

FIG. 4 illustrates, in a flowchart, operations performed by the refiner system 110 in accordance with certain embodiments. Control begins at block 400 with the refiner system 110 creating a persona profile, where the persona profile is associated with a persona and comprises a configuration that identifies data to be retrieved for the persona. In block 402, the refiner system 110 identifies a probe of a plurality of probes for the persona profile. In block 404, the refiner system 110 deploys the persona profile and the probe to one or more cloud environments of a hybrid multi-cloud environment to generate probe data. In block 406, the refiner system 110 verifies the probe data to determine whether the data to be retrieved for the persona has been retrieved and to generate verification data. In block 408, the refiner system 110 analyzes the verification data to generate one or more recommendations to refine at least one of the persona profile and the probe. In block 410, the refiner system 110 refines at least one of the persona profile and the probe based on the one or more recommendations.

With embodiments, the refiner system 110 uses a persona profile-centric approach to manage observability across hybrid multi-cloud environments 172a . . . 172n.

With embodiments, the refiner system 110 creates and ingests probes 164 into a hybrid multi-cloud environment 170. In particular, the refiner system 110 creates and ingests probes 164 into a cloud-based CI/CD pipeline based on the configurations of the persona profiles 152. The refiner system 110 distributes the persona profiles 152 across the hybrid multi-cloud environment 170. The domain and business specific requirements may be mapped into target cloud environment specific requirements (e.g., what format of data is expected). The refiner system 110 provides enforcement of continuous observability through logs, traces, and monitoring data 184 and persona profiles 152 on cloud resources and services.

With embodiments, the refiner system 110 provides periodic persona profile refinement through analytics based learning from users (e.g., who may update the persona profiles 152), resources, utilization metrics, and feedback from the personas (e.g., developers). The refiner system 110 identifies areas for decreasing or increasing observability controls. With embodiments, the refiner system 110 uses auto-start or stop specific observability knobs depending on the patterns observed or identified by the analytics engine 140 and depending on the persona profile 152. The knobs refer to on/off controls to switch on or switch off a probe 164 based on whether that probe 164 is to be prioritized or deprioritized.

With embodiments, the refiner system 110 provides information and recommendations on observability enforcement quality and observability assurance.

With embodiments, the refiner system 110 allows different kinds of users to provide persona based persona profiles 152 (e.g., prioritizing log requirements that are relevant to performing a particular job in domain, technology, and business specific terms), which are defined in user defined formats. Once the persona profiles 152 are initially created by the users, the IMCO orchestrator 120 collects the persona profiles 152 and creates persona profile to probe mappings 166 based on the domain, technology, and business specific terms in the persona profile 152 and cloud provider specific filters, and stores the mappings in the probes library 162. For example, observability tools may provide various techniques for filtering the logs, traces, and monitoring data (e.g., via search and sort based on criteria). In certain embodiments, the mappings 166 may be created or updated by a system administrator.

With embodiments, the IMCO orchestrator 120 retrieves probes from the probes library 162 and ingests/deploys the probes 164 into the CI block 226.

With embodiments, the probes 164 extract probe data 192, which may be described as hybrid cloud observability data. The analytics engine 140 performs enforcement of the probes 164 and analysis of observability.

With embodiments, the refiner system 110 continuously learns, optimizes, and stores refined persona profiles 152 and stores probes 164 (in the probe library 162) making it a closed loop solution.

With embodiments, the refiner system 110 provides a persona-friendly approach, which reduces time spent in log analysis. The refiner system 110 induces persona profiles 152 in existing CI/CD blocks. The refiner system 110 provides effective log profile policy enforcement/validation/refinement in a hybrid multi-cloud environment 170.

With embodiments, the refiner system 110 utilizes existing independent observability data of individual cloud environments 172a . . . 172n and consolidates that data to suit different personas. The refiner system 110 continuously learns and adapts the probes 164 by enriching the probes library 162 based on analytics.

With embodiments, the refiner system 110 provides a continuous feedback and refinement loop for long term adaptation in a hybrid multi-cloud environment 170.

With embodiments, there may be a large quantum of logs, traces, and/or monitoring data 184. In a hybrid multi-cloud environment 170, there may be a large set of resources and applications creating telemetry and logs (i.e., the logs, traces, and/or monitoring data 184). The large quantum of logs, traces, and/or monitoring data 184 from various sources in hybrid multi-cloud environments 170 may relate to cloud resources at various levels (e.g., infrastructure level, application level, cloud services level, distributed traces level, network level, failure level, threshold-based levels, etc.). The refiner system 110 identifies the correct set of logs, traces, and/or monitoring data 184 across hybrid multi-cloud environments 170 for a user based on a persona profile 152 for that user.

With embodiments, the refiner system 110 works with various cloud specific implementations/complexity. The refiner system 110 is able to validate or enforce a policy across multiple cloud environments, application features across the multiple cloud environments or scenarios across the multiple cloud environments.

Because it is difficult for a specific persona to go through the large quantum of log sources, timestamps, and frequencies to get business or application specific insights, the refiner system 110 provides self-optimizing persona based logs, traces, and monitoring data 184. The refiner system 110 is capable of self-learning to optimize the settings for specific collections of telemetry from the observability data 182.

The refiner system 110 leverage hybrid cloud capabilities, defining and enforcing persona based persona profiles that are enriched over a period of time by running analytics to validate observability through analytics, such as hybrid multi-cloud persona usages and log effectiveness.

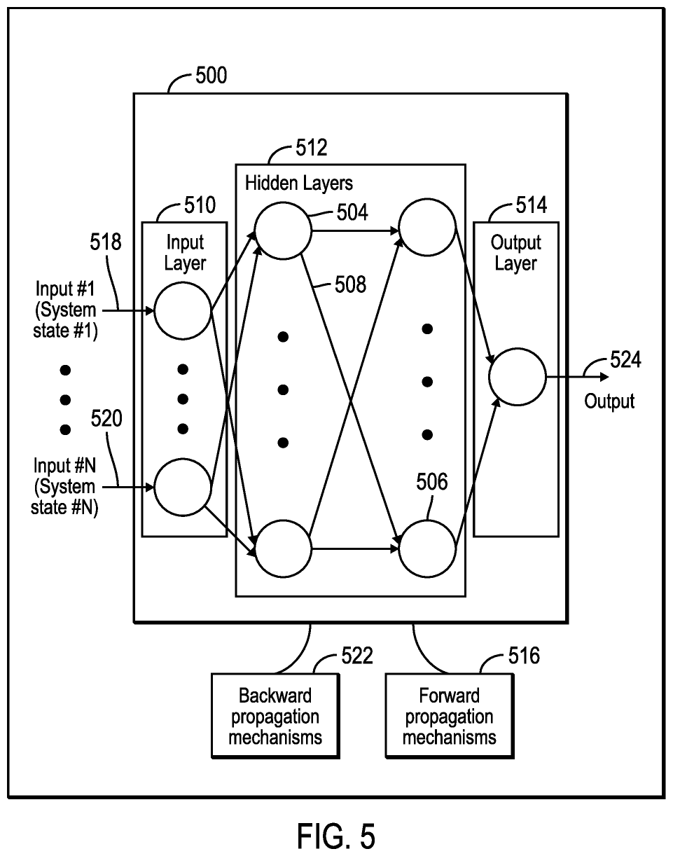

FIG. 5 illustrates, in a block diagram, details of a machine learning model 500 in accordance with certain embodiments. In certain embodiments, the analytics engine 140 is implemented using the components of the machine learning model 500.

The machine learning model 500 may comprise a neural network with a collection of nodes with links connecting them, where the links are referred to as connections. For example, FIG. 5 shows a node 504 connected by a connection 508 to the node 506. The collection of nodes may be organized into three main parts: an input layer 510, one or more hidden layers 512, and an output layer 514.

The connection between one node and another is represented by a number called a weight, where the weight may be either positive (if one node excites another) or negative (if one node suppresses or inhibits another). Training the machine learning model 500 entails calibrating the weights in the machine learning model 500 via mechanisms referred to as forward propagation 516 and backward propagation 522. Bias nodes that are not connected to any previous layer may also be maintained in the machine learning model 500. A bias may be described as an extra input of 1 with a weight attached to it for a node.

In forward propagation 516, a set of weights are applied to the input data 518 . . . 520 to calculate the output 524. For the first forward propagation, the set of weights may be selected randomly or set by, for example, a system administrator. That is, in the forward propagation 516, embodiments apply a set of weights to the input data 518 . . . 520 and calculate an output 524.

In backward propagation 522 a measurement is made for a margin of error of the output 524, and the weights are adjusted to decrease the error. Backward propagation 522 compares the output that the machine learning model 500 produces with the output that the machine learning model 500 was meant to produce, and uses the difference between them to modify the weights of the connections between the nodes of the machine learning model 500, starting from the output layer 514 through the hidden layers 512 to the input layer 510, i.e., going backward in the machine learning model 500. In time, backward propagation 522 causes the machine learning model 500 to learn, reducing the difference between actual and intended output to the point where the two come very close or coincide.

The machine learning model 500 may be trained using backward propagation to adjust weights at nodes in a hidden layer to produce adjusted output values based on the provided inputs 518 . . . 520. A margin of error may be determined with respect to the actual output 524 from the machine learning model 500 and an expected output to train the machine learning model 500 to produce the desired output value based on a calculated expected output. In backward propagation, the margin of error of the output may be measured and the weights at nodes in the hidden layers 512 may be adjusted accordingly to decrease the error.

Backward propagation may comprise a technique for supervised learning of artificial neural networks using gradient descent. Given an artificial neural network and an error function, the technique may calculate the gradient of the error function with respect to the artificial neural network's weights.

Thus, the machine learning model 500 is configured to repeat both forward and backward propagation until the weights of the machine learning model 500 are calibrated to accurately predict an output.

The machine learning model 500 implements a machine learning technique such as decision tree learning, association rule learning, artificial neural network, inductive programming logic, support vector machines, Bayesian models, etc., to determine the output value 524.

In certain machine learning model 500 implementations, weights in a hidden layer of nodes may be assigned to these inputs to indicate their predictive quality in relation to other of the inputs based on training to reach the output value 524.

With embodiments, the machine learning model 500 is a neural network, which may be described as a collection of “neurons” with “synapses” connecting them.

With embodiments, there may be multiple hidden layers 512, with the term “deep” learning implying multiple hidden layers. Hidden layers 512 may be useful when the neural network has to make sense of something complicated, contextual, or non-obvious, such as image recognition. The term “deep” learning comes from having many hidden layers. These layers are known as “hidden”, since they are not visible as a network output.

In certain embodiments, training a neural network may be described as calibrating all of the “weights” by repeating the forward propagation 516 and the backward propagation 522.

In backward propagation 522, embodiments measure the margin of error of the output and adjust the weights accordingly to decrease the error.

Neural networks repeat both forward and backward propagation until the weights are calibrated to accurately predict the output 524.

In certain embodiments, the inputs to the machine learning model 500 are persona profiles 152 and verification data 194, and the outputs of the machine learning model 500 are recommendations. In certain embodiments, the machine learning model may be refined based on whether the outputted recommendations, once taken, generate positive outcomes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

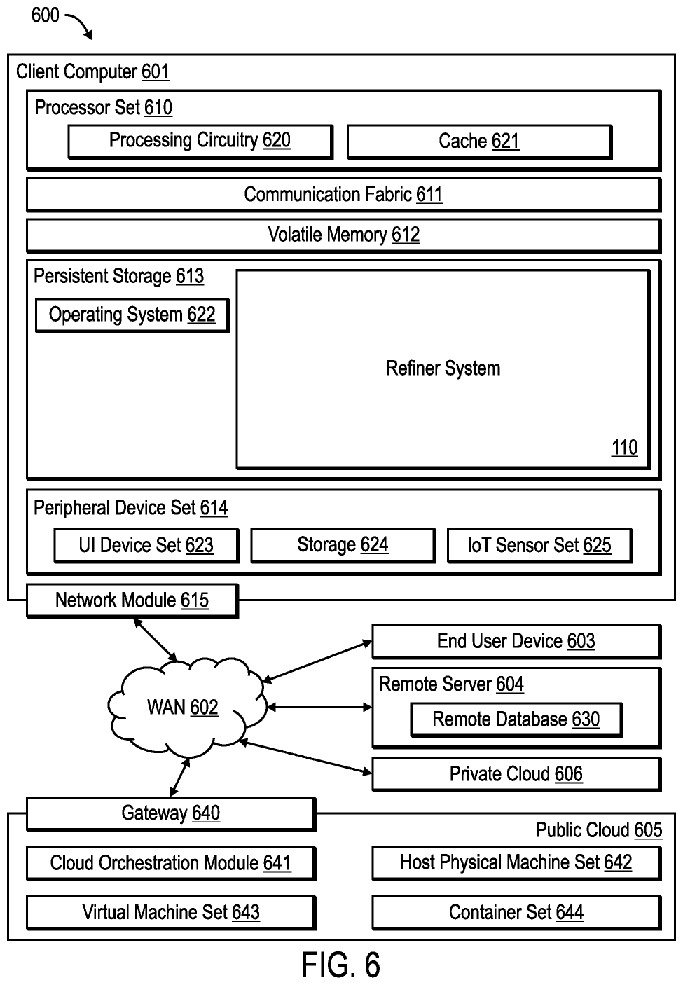

FIG. 6 illustrates a computing environment 600 in accordance with certain embodiments. Computing environment 600 contains an example of an environment for the execution of at least some of the computer code involved in performing the inventive methods, such as a refiner system 110 with distributed hybrid multi-cloud observability assurance. In addition to block 110, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 110, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 110 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 110 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Additional Embodiment Details

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise. The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended.

The foregoing description provides examples of embodiments of the invention, and variations and substitutions may be made in other embodiments.

What is claimed is:

1. A computer-implemented method, comprising operations for:
creating a persona profile, wherein the persona profile is associated with a persona and comprises a configuration that identifies data to be retrieved for the persona;
identifying a probe for the persona profile;
deploying the persona profile and the probe to one or more cloud environments of a hybrid multi-cloud environment to generate probe data;
verifying the probe data to determine whether the data to be retrieved for the persona has been retrieved and to generate verification data;
analyzing the verification data to generate one or more recommendations to refine at least one of the persona profile and the probe; and
refining at least one of the persona profile and the probe based on the one or more recommendations.

2. The computer-implemented method of claim 1, wherein the persona is one of: role-based, operations-based, and custom.

3. The computer-implemented method of claim 1, wherein the analyzing further comprises using a machine learning model.

4. The computer-implemented method of claim 1, further comprising operations for:
storing the persona profile in a version control system; and
ingesting the persona profile.

5. The computer-implemented method of claim 1, further comprising operations for:
performing centralized logging, distributed tracing, and monitoring.

6. The computer-implemented method of claim 1, further comprising operations for:
deploying the refined probe.

7. The computer-implemented method of claim 1, further comprising operations for:
returning the probe data to a user associated with the persona.

8. A computer program product, the computer program product comprising a computer readable storage medium having program code embodied therewith, the program code executable by at least one processor to perform operations for:
creating a persona profile, wherein the persona profile is associated with a persona and comprises a configuration that identifies data to be retrieved for the persona;
identifying a probe for the persona profile;
deploying the persona profile and the probe to one or more cloud environments of a hybrid multi-cloud environment to generate probe data;
verifying the probe data to determine whether the data to be retrieved for the persona has been retrieved and to generate verification data;
analyzing the verification data to generate one or more recommendations to refine at least one of the persona profile and the probe; and
refining at least one of the persona profile and the probe based on the one or more recommendations.

9. The computer program product of claim 8, wherein the persona is one of: role-based, operations-based, and custom.

10. The computer program product of claim 8, wherein the analyzing further comprises using a machine learning model.

11. The computer program product of claim 8, wherein the program code is executable by the at least one processor to perform further operations for:
storing the persona profile in a version control system; and
ingesting the persona profile.

12. The computer program product of claim 8, wherein the program code is executable by the at least one processor to perform further operations for:
performing centralized logging, distributed tracing, and monitoring.

13. The computer program product of claim 8, wherein the program code is executable by the at least one processor to perform further operations for:
deploying the refined probe.

14. The computer program product of claim 8, wherein the program code is executable by the at least one processor to perform further operations for:
returning the probe data to a user associated with the persona.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
creating a persona profile, wherein the persona profile is associated with a persona and comprises a configuration that identifies data to be retrieved for the persona;
identifying a probe for the persona profile;
deploying the persona profile and the probe to one or more cloud environments of a hybrid multi-cloud environment to generate probe data;
verifying the probe data to determine whether the data to be retrieved for the persona has been retrieved and to generate verification data;
analyzing the verification data to generate one or more recommendations to refine at least one of the persona profile and the probe; and
refining at least one of the persona profile and the probe based on the one or more recommendations.

16. The computer system of claim 15, wherein the persona is one of: role-based, operations-based, and custom.

17. The computer system of claim 15, wherein the analyzing further comprises using a machine learning model.

18. The computer system of claim 15, wherein the operations further comprise:
storing the persona profile in a version control system; and
ingesting the persona profile.

19. The computer system of claim 15, wherein the operations further comprise:
performing centralized logging, distributed tracing, and monitoring.

20. The computer system of claim 15, wherein the operations further comprise:
deploying the refined probe.
